(19) United States
(12) Patent Application Publication
(10) Pub. No.: US 2013/0223678 A1
(43) Pub. Date: Aug. 29, 2013

(54) Time in Line Tracking System and Method

(71) Applicant: Sam F. Brunetti, Arlington, VA (US)

(72) Inventor: Sam F. Brunetti, Arlington, VA (US)

(73) Assignee: BAS STRATEGIC SOLUTIONS, INC., Gainsville, VA (US)

(21) Appl. No.: 13/404,457

(22) Filed: Feb. 24, 2012

(51) Int. Cl. G06K 9/00

(52) U.S. Cl. 382/103

(57) ABSTRACT

A method of determining the amount of time it will take a person (P) waiting in a line (L) to move between two points. The method includes acquiring a facial pattern of the person when they are at a first point in the line and establishing the time at which the facial pattern was obtained. Next, a facial pattern of the person is acquired when the person arrives at a second point in the line. The two facial patterns are compared and when a match is found, a lapsed time is established. By subtracting the two times the transit time of the person from the first point to the second point is established and this time is displayed at the entry point of the line.

### CROSS-REFERENCE TO RELATED APPLICATIONS

None

### STATEMENT REGARDING FEDERALLY SPONSORED RESEARCH

Not Applicable.

### BACKGROUND OF THE INVENTION

This invention relates to the flow of people waiting in line at airports or in other venues; and, more particularly, to a method and apparatus for providing those in line an indication of approximately how much time it will take them to advance from one point in the line to another point therein.

The most common waiting lines encountered these days are in airports where airline passengers have to pass through a security checkpoint in order to move from a non-secure area within the airport (e.g., a ticketing counter or waiting area) to a secure area (e.g., the concourse where the gates for boarding planes are located). Passengers entering the checkpoint area typically want to know approximately how long it is going to take them to get through the checkpoint; and especially, how long they must wait before having their documents checked so they can begin the actual screening process. Knowing an approximate wait time helps reduce passengers' anxiety. This is because not only does almost everyone hate waiting in lines, but many passengers arrive at the checkpoint relatively soon before their flight's departure, and therefore worry about making it to their gate in time to board their flight.

The ability to inform passengers what their wait time also does a number of things. For one, it helps travelers be prepared to present their documents to a security person when their turn comes. Seeing posted wait times also encourages individuals to get in line sooner and thus avoid feeling rushed later. It also helps address passenger complaints about wait times, line management, etc.

Knowing how long it takes passengers get through security checkpoints helps the Transportation Security Administration (TSA) to monitor and manage the efficiency of its screening staff, procedures and equipment. Operational improvements can be configured, tested and deployed by knowing time-in-line information. Also, comparing this data across screening lanes (or established norms) can aid in highlighting possible system, personnel or procedural problems so they can be timely addressed.

The Time In Line Tracking System (TILTS) and method of the present invention address these issues which face both today's travelers public and the TSA. Providing accurate wait time information helps passengers understand when they need to begin the screening process which should help relieve their anxiety about being late for a flight. Helping the TSA understand how long the ID verification and security screening processes take should help it decide if additional personnel, or different personnel or procedures, are needed at an airport. The TSA will also better be able to evaluate individual screening lane timing performance and this should help it determine which lanes in an airport need more personnel to improve passenger throughput, or which equipment and processes will safely process people faster.

### BRIEF SUMMARY OF THE INVENTION

In accordance with the present invention, TILTS is designed to accurately estimate the length of time it will take a person moving in a line to move from one point to another. Typically, this is how long a person can expect to wait in a line (or lines) before gaining entry into another area or space; i.e., the common (unrestricted) area in an airport into a secure (restricted) area or concourse.

It is a feature of TILTS that it is an automated system. It does not rely on human observation, intervention or management of the system to make a wait-time calculation. Also, the calculated time is periodically, or continually, updated with time-in-line information based on a computerized analysis of system data obtained over time.

In airport applications, TILTS is deployed in passenger, crew and employee screening queues at airport security checkpoints. Importantly, in such environments, TILTS can objectively estimate the wait interval regardless of the security equipment, personnel or procedures in use at the checkpoint. The time in line calculation includes both the length of time an individual entering the roped off or stanchion guide area in front of a security checkpoint can expect to wait before reaching the security person reviewing their travel documents; as well as the length of time it takes the individual to proceed from there through the screening area itself. This latter includes all pre-screening activities (shoe and belt removal, etc.), the primary screening, any secondary screening the passenger may have to undergo, and post screening activities (putting their shoes and belt back on, etc.) before the person moves into the concourse.

It is a further feature of the invention that, for all its functionality, TILTS has small footprint requirements, and needs almost no user interface or management oversight to automatically produce objective passenger flow data. In addition, TILTS message boards can be programmed to convey not only time in line information, but also other information to the public; e.g., reminders about screening processes, temporary alerts or requests, and other information a screening checkpoint manager decides is helpful.

Other objects and features will be in part apparent and in part pointed out hereinafter.

### BRIEF DESCRIPTION OF THE SEVERAL VIEWS OF THE DRAWINGS

FIG. 1 is a representation of a typical airport screening checkpoint with which the TILTS is used; and,

FIG. 2 is a representation of a layout of TILTS.

Corresponding reference characters indicate corresponding parts throughout the several views of the drawings.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

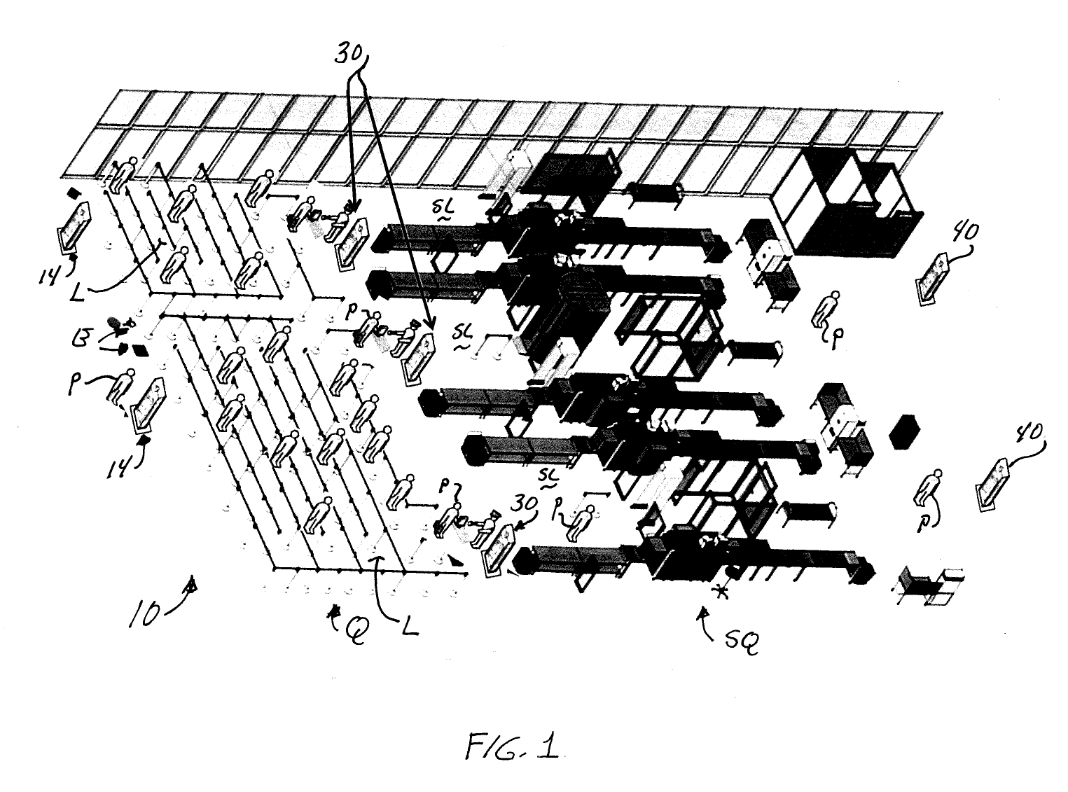

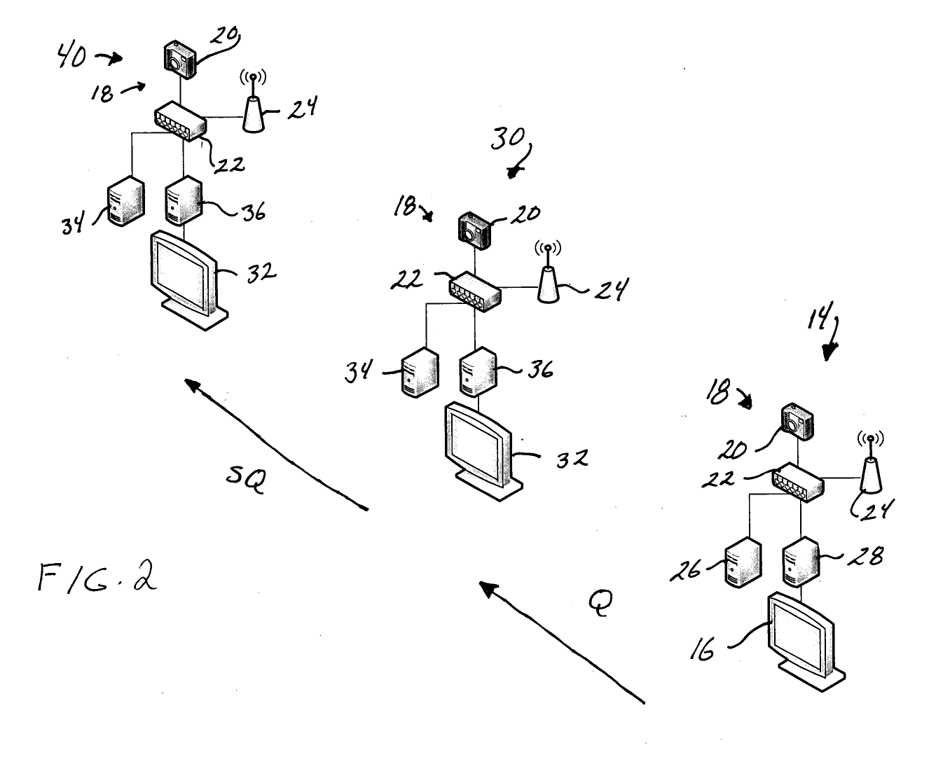

As shown in FIG. 1, TILTS is indicated generally 10 and first is used with a pre-screening queue indicated generally Q. At an entrance E to queuing area Q (which includes a line L defined by ropes and stanchions or the like) is an information pedestal 14 of TILTS. Pedestal 14 includes a dynamic electronic messaging sign 16 which displays wait time or time-in-line, and other pertinent information. An imaging means indicated generally 18 is also incorporated into the pedestal. The imaging means views people P as they enter queue Q. Referring to FIG. 2, which illustrates a typical airport security screening pedestal configuration, imaging means 18 includes, for example, a camera 20 connected to a network hub unit 22. In addition to camera 20, hub unit 22 is further connected to a wireless data link 24 which sends and receives data and other information throughout TILTS 10, a dynamic electronic message host 26 which processes the information displayed on sign 16, and a facial recognition enrollment host 28 which includes a microprocessor. The microprocessor runs software designed to process facial images of people captured by camera 20. These can either be a single individual's image (referred to as a “one off”); or, an image of a group comprising two or more individuals (this is referred to as “divisional averaging”).

Each image, whether “one off” or “divisional-averaging”, is date and time stamped, and then packetized for wireless transmission to a receiving station (information pedestal) 30 at the other end of pre-screening queue Q. In an airport, this end of queue Q is where security personnel are stationed to inspect a traveler's documents. Referring to FIG. 2, receiving station 30 is similarly configured to pedestal 14. That is, pedestal 30 includes a static electronic messaging sign 32, a camera 20, and a network hub unit 22 connected to a wireless data link 24. In pedestal 30, hub unit 22 is now connected to a time/data and sequencing management system 34, and a facial recognition correlation host 36 which includes a microprocessor. The microprocessor runs software designed to process facial images of people taken by the camera 20 at pedestal 30 and compare them with the facial images of people taken at pedestal 14.

The microprocessor operating at receiving station 30 receives and temporarily holds transmitted image packets from pedestal 14 until the individual, or group of individuals, come into view of the camera 20 built into the pedestal 30. The facial recognition software operated by the microprocessor seeks to match images obtained at pedestal 14 with those now obtained at pedestal 30. When a match occurs, the microprocessor calculates how much time has elapsed between when the pedestal 14 images were captured and when these images were matched up with the images obtained at pedestal 30. The calculated time represents the time required to traverse lane L of pre-screening queue Q. Importantly, divisional averaging of a group of images provides a basis for comparison and time determination even when someone's image is not found due to the person having left the line of queue Q, or by the person not have been looking at the camera 20 at pedestal 14. Thus, the time through the queue can still be determined by matching other passengers' images (whether taken individually or in a group) transmitted in a packet from pedestal 14 to pedestal 30.

As image matches are made and the length of time passing through queue Q is determined, wait-time data is regularly transmitted back to pedestal 14 to update the passage time message displayed on sign 16; this being the expected duration newly approaching passengers, crew, etc., can expect to be in queue Q.

The timing determination performed by TILTS is adjustable. That is, TILTS determines queue Q passage time calculation as often, or as infrequently, as established by the system's administrator. For example, the system can be set to display a standard wait-time message; e.g., “less than a five minute wait”, when few people are in the queue. However, at busy or peak times, TILTS can be adjusted to recalculate passage time as often as every image comparison. Once a line of sufficient length forms so that line duration exceeds five minutes, TILTS automatically starts the image packet cycle so to get an accurate wait time (which will be in excess of five minutes).

TILTS also operates in a number of other timing modes. TILTS can be set to perform a calculation at a pre-determined interval such as every one minute, every five minutes, etc. In addition, besides performing these calculations and updating the display of messaging sign 16 with each result, TILTS is programmed to also display an average wait time based upon intervals calculated over a set period of time. For example, the displayed wait time can be calculated over a 30-minute interval in which six successive five-minute intervals are averaged and the result displayed on messaging sign 16. TILTS is also programmable to wait to start a timing cycle until a current cycle; i.e., one with the captured images seen at receiving station 30, is completed.

In the airport environment depicted in FIG. 2, at the end of queue Q, the passengers travel documents are scrutinized by TSA personnel. If the documents are found to be in order, the person now enters a security screening queue SQ. To determine wait time for this queue, the same general process previously described is used. Here though, the difference is in the number and positioning of receiving end pedestals 40. This is because multiple screening lanes SL are now available; and, depending upon the particular airport, concourse, etc., the exact number and configuration of these lanes and hence the number of pedestals 40 varies.

Each screening lane SL has a single pedestal 30 stationed in its path from entry queue Q to a screening queue SQ. At the other end of the screening queue, a single pedestal 40 is positioned to capture facial images of all the people exiting the multiple screening lanes. Two such pedestals 40 are shown in FIG. 1 to cover three screening lanes. As is known in the art, while most people P pass the initial screening process, some individuals may be subjected to a secondary screening. It is a feature of TILTS that some, or all, screening lanes can have two pedestals 40 to separately calculate the time it takes to process both those who satisfy the initial screening and those who require a secondary screening.

Regardless of pedestal configuration, each screening lane has entrance and exit pedestals, 30 and 40 respectively. Pedestal 40, as with pedestal 30, includes a static electronic messaging sign 32, a camera 20, and a network hub unit 22 connected to a wireless data link 24. The hub unit is connected to a time/data and sequencing management system 34, and a facial recognition correlation host 36 which includes a microprocessor. Again, the microprocessor runs software designed to capture, process, and compare the facial images of people. Operation of host 36 in pedestal 40 is to compare the images from each of the pedestals 30 taken when the person enters screening queue SQ, regardless of their point-of-entry into the queue, and when a match is made, display the wait time on the messaging sign 32 on the pedestals 30 at the entrance to the queue.

In addition to the above described processing, the facial recognition matching and time calculation software of TILTS can be used to calculate and display a variety of wait items, depending on the number and configuration of receiving pedestals. This helps take into account the specific needs of a particular airport, enables monitoring of the performance of difference types of screening equipment, as well as other parameters required or requested by the TSA.

It will be appreciated that some people dislike facial recognition technologies because of privacy concerns. Accordingly, TILTS may employ other processes for calculating queue durations; although these other approaches have certain drawbacks which may make them unacceptable for general use. These drawbacks include both technical and supervisory limitations, as well as public perceptions. For example, TILTS could use cell phone signals to track individuals as they worked their way through the pre-screening and security screening queues Q and SQ; but, the public is wary of mobile device tracking, whether by the government or others.

TILTS can also be used by having a person take a card from a station (i.e., pedestal 14) at the beginning of the line and inserting it in a station (i.e., pedestal 30) at the end of the line. In this approach, a timing cycle is started and stopped based on a tag within the card being recognized at both stations, and the waiting or passage time is calculated as the time between the two events. A drawback with this approach is that it requires a high degree of passenger compliance. Also, because the passenger must insert a card at each station and wait for it to be recognized, it will tend to slow movement through the queue. Further, the tags either have to be recycled (i.e., retrieved from the second station and returned to the first station); or, thrown away and replaced with new tags which, over time, becomes expensive.

Facial recognition eliminates the issues associated with these other approaches; while, both being completely automated and providing a much higher level of accuracy: The latter is true because everyone's facial characteristics are unique and are managed as a guaranteed one-to-one match within the system. Accordingly, there is no need to hunt for, or lock onto, peoples' personal mobile devices. No passenger interaction is required to start or stop the TILTS timing cycle. And, TILTS does not produce expendables or require someone to stock or empty receptacles at the pedestals.

Next, the data TILTS collects; i.e., facial images, is not personally identifying information. Rather, each face is simply a unique map or configuration of features that the system does not recognize or identify with any given person. In fact, TILTS has no understanding of people. Instead, TILTS only uses a facial “map” to start and stop a timing cycle with the facial map making sure the system is comparing two images of a unique thing; in this instance, a person's face. Once matching is complete, TILTS purges the facial images because it has no image storage capability. What remains after a match is completed is only a date and time stamp file, with the line duration data transferred to a system file for subsequent timing analysis.

Overall, TILTS is advantageous in that it calculates and displays the length of time an individual entering a roped-off area or queue can expect to wait to reach the security person reviewing travel documents before each the person is directed to a screening area. This is so regardless of whether the passage for the queue is a straight line; or, as shown in FIG. 1, a line that extends back and forth upon itself so to create a small “footprint” while accommodating a large number of people. TILTS is further advantageous in that it calculates and displays the length of time it takes the person to then proceed through a screening lane. The calculated time includes the time required for all pre-screening activities (such as removing shoes and outwear, placing carry-on items in bins and on conveyor belts, etc.), the amount of time required for each individual and their belongings to successfully pass through the security checkpoint's equipment and processes, and the time required for any secondary screening or advanced screening requirements.

In view of the above, it will be seen that the several objects and advantages of the present disclosure have been achieved and other advantageous results have been obtained.

1. A method of determining the amount of time it will take a person waiting in line to move between two points comprising:
acquiring a facial pattern of the person when they are at a first point in the line and establishing the time at which the facial pattern was obtained;
acquiring the facial pattern of each person in line when they arrive at a second point in the line;
comparing the facial pattern of each person obtained when they reach the second point with the facial pattern of the person obtained at the first point; and,
establishing the time when a facial pattern match is made, this being indicative of the person having arrived at the second point, and subtracting the two times to determine the transit time of the person from the first point to the second point.

2. The method of claim 1 further including displaying the calculated transit time to persons in line to provide them an indication of how long it will take them to move from the first point to the second point.

3. The method of claim 2 in which acquiring the facial pattern of a person at the first and second points includes obtaining an image of the person at each point and comparing the two images at the second point to find an image match.

4. The method of claim 3 further including performing a divisional averaging of a group of images at the second point to provide a basis for comparison and time determination so even if a person's image is not found at the second point because the person either left the line or because an imaging means at the first point did not capture their image, for the time in line to still be determined by matching other peoples' images substantially contemporaneously obtained at the first point.

5. The method of claim 2 in which a standard transit time display is made until the calculated line wait exceeds a predetermined minimum time.

6. The method of claim 2 in which transit time calculations are made, and the display updated, at predetermined time intervals.

7. The method of claim 2 in which transit time calculations are made, and the display updated, every time a facial pattern match is made.

8. The method of claim 2 in which the displayed wait time is calculated as an average of a predetermined number of wait time calculations made over a fixed interval.

9. The method of claim 1 which does not store the facial images of people, but only a date and time stamp of the transit time by a person.

10. A method of determining the amount of time it takes a person to move from a first station at the beginning of a queue to a second station at the end of the queue by acquiring the facial pattern of the person at the first station and comparing it against that of people reaching the second station, and when a comparison of facial patterns indicates the person has reached the second station measuring the elapsed time between when the facial pattern was acquired at the first station and when the person was identified as having reached the second station based on the comparison of the two facial patterns; and, providing a visual indication of the elapsed time to people arriving at the first station so they know approximately how long it will take them to move between the first station and the second station.

11. The method of claim 10 further including a second queue which the person enters after leaving the first queue, and the method further including measuring the elapsed time it takes the person to move through the second queue.

12. The method of claim 11 in which the facial pattern of the person acquired at the second station is compared with a facial pattern of the person acquired when the person reaches a third station at the end of the second queue.

13. The method of claim 12 in which the second queue has a plurality of third stations and a comparison of facial patterns is performed at each third station to find a match.

14. A system for determining the amount of time it takes a person to move from a first station at the beginning of a queue to a second station at the end of the queue, comprising:
imaging means at each station for acquiring the facial pattern of the person:
comparison means at the second station for comparing the facial pattern of a person acquired at the first station against that of people reaching the second station, and when a comparison of facial patterns indicates the person has reached the second station measuring the elapsed time between when the facial pattern was acquired at the first station and when the person was identified as having reached the second station based on the comparison of the two facial patterns; and,
means providing a visual indication of the elapsed time at the first station so people arriving at the first station know approximately how long it will take them to move from the first station to the second station.

15. The system of claim 14 further including a third station to which people move after reaching the second station, the system further including:
imaging means at the third station for acquiring the facial pattern of the person reaching the third station:
comparison means at the third station for comparing the facial pattern of a person acquired at the first or second station against that of people reaching the third station, and when a comparison of facial patterns indicates the person has reached the third station measuring the elapsed time between when the facial pattern was acquired at the second station and when the person was identified as having reached the third station based on the comparison of the two facial patterns; and,
means at the second station providing a visual indication of the elapsed time at the second station so people arriving at the second station know approximately how long it will take them to move from the second station to the third station.

16. The method of claim 15 further including performing a divisional averaging of a group of images at the second station to provide a basis for comparison and time determination so even if a person's image is not found at the second station because the person either left the line or because an imaging means at the first station did not capture their image, for the time in line to still be determined by matching other peoples' images substantially contemporaneously obtained at the first station.

17. The method of claim 15 in which a standard transit time display is made at each of the second and third stations until the calculated line wait exceeds a predetermined minimum time.

18. The method of claim 17 in which transit time calculations are made, and the display updated, at predetermined time intervals.

19. The method of claim 17 in which transit time calculations are made, and the display updated, every time a facial pattern match is made.
